(19) United States
(12) Patent Application Publication
(10) Pub. No.: US 2013/0124357 A1
(43) Pub. Date: May 16, 2013

(54) System and method for online buying and selling goods and services within the context of social networking

(71) Applicants: Zhijiang He, Sunnyvale, CA (US); Jiafang Xiao, (US)

(72) Inventors: Zhijiang He, Sunnyvale, CA (US); Jiafang Xiao, (US)

(73) Assignee: ZHIJIANG HE, Sunnyvale, CA (US)

(21) Appl. No.: 13/373,527

(22) Filed: Nov. 16, 2011

(51) Int. Cl. G06Q 30/08

(52) U.S. Cl. 705/26.3; 705/26.41

(57) ABSTRACT

A system and method is provided for online buying and selling goods and services within the context of social networking. The social relation closeness between a buyer and a seller is determined using information from social networking services and a business transaction record database. Trust and credibility between buyers and sellers may be derived from the social relation closeness between them. Therefore, the initial transaction barriers may be lowered. The business relation closeness between a buyer and a seller may be determined and may be used to search for potential buyers and sellers. Furthermore, buyers and sellers may acquire more information from their social and business relations so as to aid the sales decisions and detect frauds. To provide desired privacy and credibility, a seller may use groups and requirement on the closeness of social and business relation with the seller to control access to the seller's item information.

### CROSS-REFERENCE TO RELATED APPLICATIONS

13317270, “A method for calculating distances between users in a social graph”, Oct. 13, 2011, pending, Zhijiang He

13317794, “A method for calculating proximities between nodes in multiple social graphs”, October 28, pending, Zhijiang He

### FEDERALLY SPONSORED RESEARCH

Not Applicable

### SEQUENCE LISTING OR PROGRAM

Not Applicable

### US PATENT REFERENCES

Not Applicable

### OTHER REFERENCES

“Six degrees of separation”, http://en.wikipedia.org/wiki/Six_degrees_of_separation

### FIELD OF THE INVENTION

The present invention relates to online buying and selling goods and services. More specifically, the present invention relates to online buying and selling goods and services within the context of social networking.

### BACKGROUND OF THE INVENTION

Online buying and selling goods and services is norm of people's life. The revenue of eBay Inc. in 2010 is $9.2 billion. The revenue of Amazon.com Inc. in 2010 is $34.20 billion.

Due to lack of face-to-face sales support, online shopping and auction customers heavily rely on goods and services' descriptions, images and videos to understand the listed goods and services. Customers' feedbacks, ratings, comments and consumer forums, if available, may also be helpful. On the other hand, sellers may rely on possible ratings on buyers by other sellers to know more about potential buyers. Online shopping/auction sites and payment service providers may also provide various anti-fraud protection services. Nonetheless, sometimes buyers and sellers may still find these resources less than perfect. Moreover, even with emails, messages, phone calls, etc., the contacts and trust between sellers and buyers may still be limited. This is particularly true for first time buyers and sellers without track record.

In recent years, social networking has become more and more popular. For instance, Facebook has more than half billion users. Large databases of social connections, i.e. social graphs, have been established. More importantly, according to the 6 degrees of separation, there may be on average 5 users between any two users of a popular social networking service. In other words, a user may easily connect to any other user on a popular social networking service.

In real life, a buyer may ask his/her friends for referral of sellers. His/her friends may ask their friends for referral. Furthermore, to sell more products/services, a seller may ask customers to recommend products/services to their friends. In this real life example, friendship may be used to find possible new business opportunities.

Similarly, social networking may bring new perspectives to online buying and selling goods and services as well. More specifically, buyers and sellers may use social graphs to find new business opportunities. The relations represented by social graphs may also be used to avoid frauds and to obtain more information. Furthermore, sellers may use social graphs and groups to limit the access of item listing to a specified circle of friends, thereby achieving desired privacy and credibility.

Accordingly, it is an object of this invention to provide a system and method for online buying and selling goods and services within the context of social networking.

### BRIEF SUMMARY OF THE INVENTION

The present invention provides a system and method for online buying and selling goods and services within the context of social networking. Information of profiles, relations, groups, messages, etc., is obtained from social networking services with users' permissions. The closeness of social relation and the closeness of business relation between a buyer and a seller may be determined from the obtained information and a business transaction record database. Buyers and sellers may use the social relation closeness and the business relation closeness to make sales decisions and to avoid possible frauds. Buyers and sellers may also use the social relation closeness and the business relation closeness to acquire information about various aspects of the potential transactions. Moreover, potential buyers and sellers may be found using social relation closeness and business relation closeness.

Social graphs represent social relations between entities. The social relation between two entities may carry a certain level of trust and credibility. Entities in a social graph may include users, celebrities, public figures, artists, bands, groups, companies, businesses, organizations, institutions, places, events, brands, products and services. In this document, the terminologies entity, node and user may be used interchangeably.

The business relations between buyers and sellers may be modeled using a business graph. A business relation between a buyer and a seller means there are one or more business transactions between the buyer and the seller. A business relation between a buyer and a seller may carry a certain level of trust and credibility between the buyer and the seller. It is a type of social relations. Therefore, a business transaction record database is also a social business graph. In this document, the terminologies social business graph and business graph may be used interchangeably.

To determine closeness of social relation and business relation between buyers and sellers, in pending patent application 13317270 and 13317794, weighting factors are assigned to relations between entities in a social graph or a social business graph. Weighting factors for relations in a graph may be determined in various ways. In one embodiment of the pending patent application 13317270 and 13317794, weighting factors may be determined from the closeness of relation between two entities. In another embodiment of the pending patent application 13317794, the weighting factor for relation from a first entity to a second entity is determined from the first entity's opinion and review on the second entity. In other words, the reviews, ratings and feedbacks on buyers and sellers may be used to determine the weighting factors for relations between buyers and sellers in a business graph. In yet another embodiment of the present invention, the number of transactions between two entities may also be used to assign weighting factors to the relations in a business graph.

In pending patent application 13317270 and 13317794, distances/proximities of relation between entities may be calculated from the weighting factors for relations in social graphs including social business graphs. The calculated distances/proximities describe the closeness of social relation and the closeness of business relation between buyers and sellers.

Relations in business graphs may carry certain levels of trust and credibility between buyers and sellers. Therefore, business relation and social relation share something in common. In some cases, using methods in pending patent application 13317794, business graphs and social graphs may be merged to reflect more complete relation between a buyer and a seller.

Sometimes, for privacy reasons, a seller may not want to list his/her selling item publicly. Instead, a small circle of potential buyers are preferred. The seller may use groups either obtained from social networking services or created by the seller to limit the access of the item listing only to buyers within the groups. Moreover, a seller may require that only potential buyers having certain extent of social relation and business relation with the seller are allowed to access the selling information. In one embodiment of the present invention, a seller may only allow his/her direct friends to access information of his/her selling items.

A system in accordance with the present invention may include an e-commerce data processing system and a relation module. The e-commerce data processing system may perform the functions of a conventional e-commerce service and may provide additional relation and privacy features. The relation module may obtain information from social networking services with users' permissions and may determine the closeness of social relation and the closeness of business relation between buyers and sellers from the obtained information and a business transaction record database.

### BRIEF DESCRIPTION OF THE DRAWINGS

FIG. 1 shows a diagram for a business graph including a seller and n potential buyers according to the invention.

FIG. 2 shows a diagram for a business graph including a buyer and m potential sellers according to the invention.

FIG. 3 shows a conceptual view of a business graph in which n buyers and m sellers are connected according to the invention.

FIG. 4 shows a conceptual view in which n buyers and m sellers are connected via social graphs according to the invention.

FIG. 5 shows a social graph and a business graph according to the invention.

FIG. 6 shows a social graph with weighting factors, path proximities and proximities according to the invention.

FIG. 7 shows a diagram for a social graph and a business graph according to the invention.

FIG. 8 shows a diagram for a merged social graph from the social graph and the business graph in FIG. 7 according to the invention.

FIG. 9 shows a diagram in which relations in a social friendship graph are used to search for new buyers and sellers according to the invention.

FIG. 10 shows one embodiment of a system according to the invention.

FIG. 11 shows one embodiment of an e-commerce data processing system according to the invention.

FIG. 12 shows one embodiment of a relation module according to the invention.

FIG. 13 shows a flow chart illustrating one embodiment of how a seller lists an item on a server according to the invention.

FIG. 14 shows a flow chart illustrating one embodiment of how a buyer makes a buying request according to the invention.

FIG. 15 shows one embodiment of the listing of potential sellers to a buyer according to the invention.

FIG. 16 shows one embodiment of the listing of potential buyers to a seller according to the invention.

### DETAILED DESCRIPTION OF THE INVENTION

In the following description, numerous specific details are set forth in order to provide a thorough understanding of the invention. It will be apparent to one skilled in the art, however, that the present invention may be practiced without these specific details. Accordingly, the following embodiments of the invention are set forth without any loss of generality to, and without imposing limitations upon, the claimed invention.

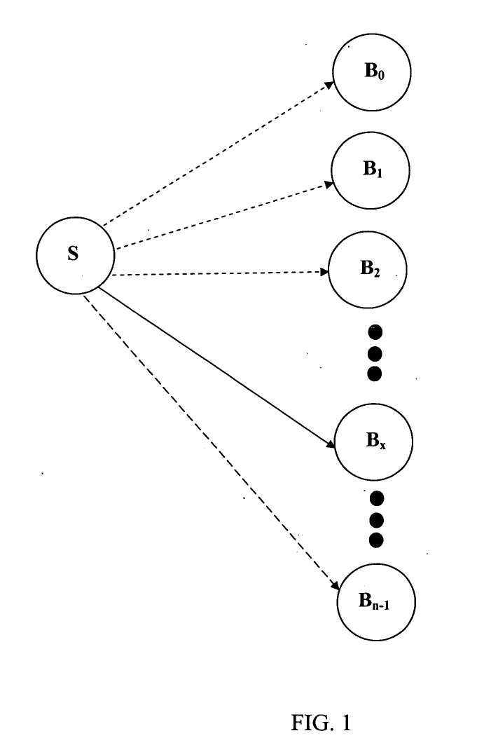

An item listed on an online shopping or auction service may be a product or service, or groups of products and services. When a seller put an item for sale, there may be a number of buyers interested in the item. The seller has to decide to whom the item may be sold. FIG. 1 shows a business graph in which a seller has n buyers. Normally, the seller may select the first buyer interested in the item. In the case of online auction, the seller may sell the item to the highest bidder within a specified auction time period. However, in most cases, credibility is a concern for on-line business transactions. Generally, a seller may only consider buyers with at least a certain level of credibility. In FIG. 1, the seller may eventually sell the item to buyer Bₓ.

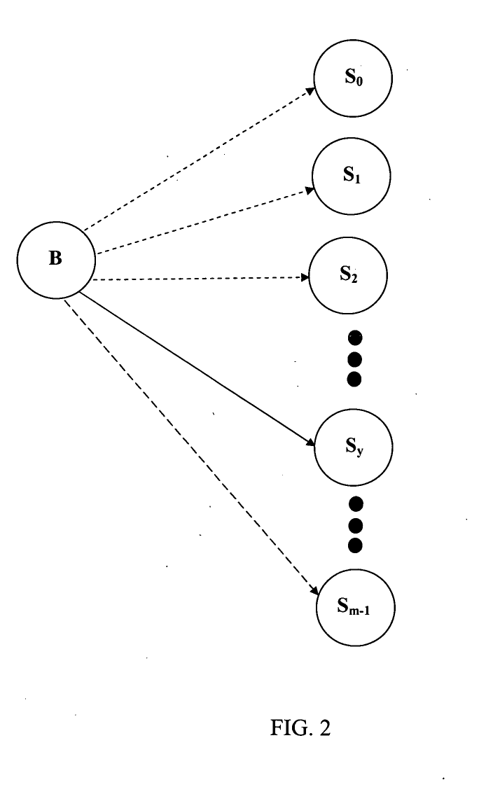

Similarly, FIG. 2 shows a business graph in which a buyer has m sellers selling similar type of goods and services. Qualities, prices and post-sale services are definitely among the most important factors in the buyer's purchase decision. However, a buyer may only consider sellers with at least a certain level of credibility. In FIG. 2, the buyer may eventually buy an item from seller S_{y}.

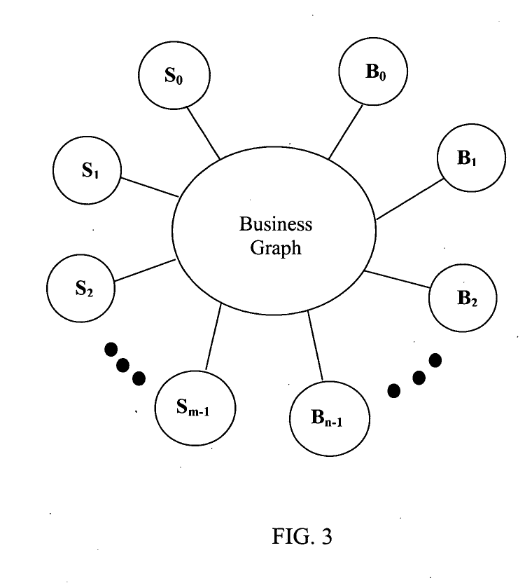

FIG. 3 shows a high level view of a business graph in which n buyers and m sellers are connected. The links in the business graph are symbolic. Each symbolic link may represent multiple links to a number of other entities in the business graph.

To avoid online frauds, credibility and trust, in most cases, are concerns for both buyers and sellers. A buyer may take other buyers' reviews, ratings and feedbacks on a seller into account. A seller may also consider a buyer's reviews, ratings and feedbacks on other sellers to collect information about the potential buyer. Unfortunately, the online reviews, ratings and feedbacks are not always trustworthy. It may also take buyers and sellers considerable time to read all the reviews, ratings and feedbacks. Moreover, buyers and sellers may have their own specific concerns not addressed by the online reviews, ratings and feedbacks.

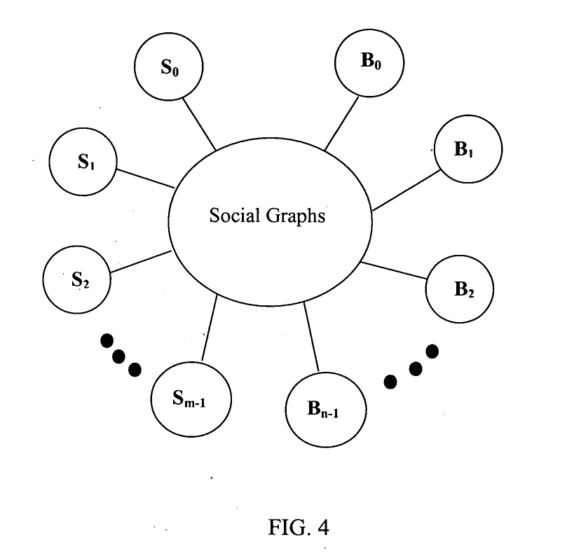

The popularity of online social networking services makes it possible to use the social graphs established by social networking services to explore new business opportunities. According to the 6 degrees of separation, a buyer may connect to a seller in a popular social graph. To put this into perspective, FIG. 4 shows a high level diagram in which n buyers and m sellers are connected in the social graphs. Similar to FIG. 3, each link in FIG. 4 is symbolic and may represent multiple links to other entities in the social graphs.

Like friendship in real world, the social graphs obtained from social networking services may carry certain levels of trust and credibility. Therefore, the social relations represented by social graphs may be used to establish the trust and credibility between buyers and sellers in online buying and selling goods and services. In other words, social graphs may lower the initial transaction barriers for online buyers and sellers.

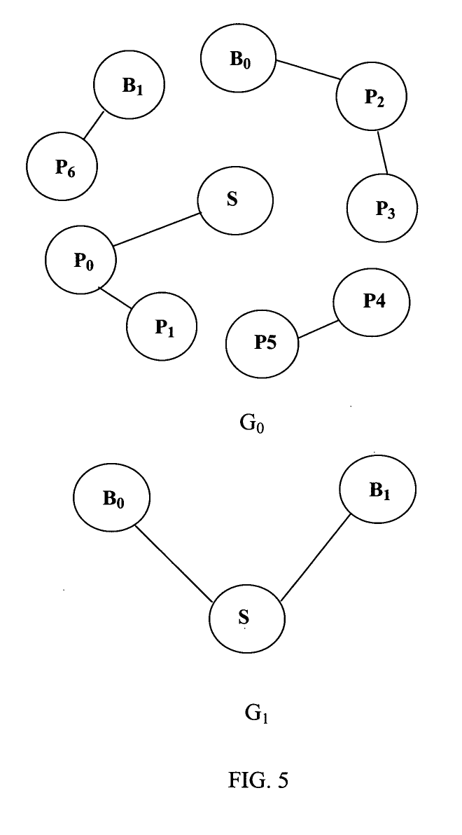

FIG. 5 shows one social graph G₀ and one business graph G₁. Seller S, buyer B₀ and B₁ are in both G₀ and G₁. The connections between S and B₀/B₁ in G₁ mean there are business transactions between S and B₀/B₁. The connections in G₀ represent social relations between two entities.

In FIG. 5, S is directly connected to P₀ in G₀, which means a direct social relation between S and P₀. This relation carries a certain level of trust and credibility between S and P₀. Nonetheless, the level of trust and credibility carried by the relation may or may not be enough to justify an online business transaction between S and P₀. This issue will be addressed later in the section. P₁ is connected to S via P₀. As friendship, trust and credibility may be propagated along a path in a social graph, S may have a certain level of trust and credibility in P₁.

P₂ and P₃ are connected to B₀ either directly or indirectly in G₀. As B₀ has conducted business transactions with S, S may have certain levels of credibility and trust in P₂ and P₃ respectively. Likewise, S may have a certain level of credibility and trust in P₆ via B₁. Please note that the levels of trust and credibility between S and P₂/P₃/P₆ may or may not be sufficient for S to sell an item to them.

Neither P₄ nor P₅ is connected to S in G₀ and G₁. With no other information, there is no way for S to determine the levels of credibility and trust in P₄ and P₅. Please note that there might be other information to establish the trust and credibility between S and P₄/P₅. For instance P₄ and P₅ may have done business with another seller whom S may trust.

As mentioned earlier, an entity connecting either directly or indirectly to another entity in social graphs may or may not qualify for an online business transaction between them. A user in a popular social graph may have hundreds of connections. Nonetheless the connections may carry disparate levels of closeness. Family relation may carry a high level of trust. In another example, if there are more communications between two nodes, the relation between them may be closer as well.

To model the closeness of relation between nodes in graphs, in pending patent application 13317270 and 13317794, weighting factors are assigned to the relations in a graph. Given a graph G(V, E), V represents the set of nodes in G and E represents the set of edges connecting the nodes in V. For a relation eᵢⱼ, wᵢⱼ is used to describe the closeness of relation from vᵢ to vⱼ. Please note that G may represent a business graph as well.

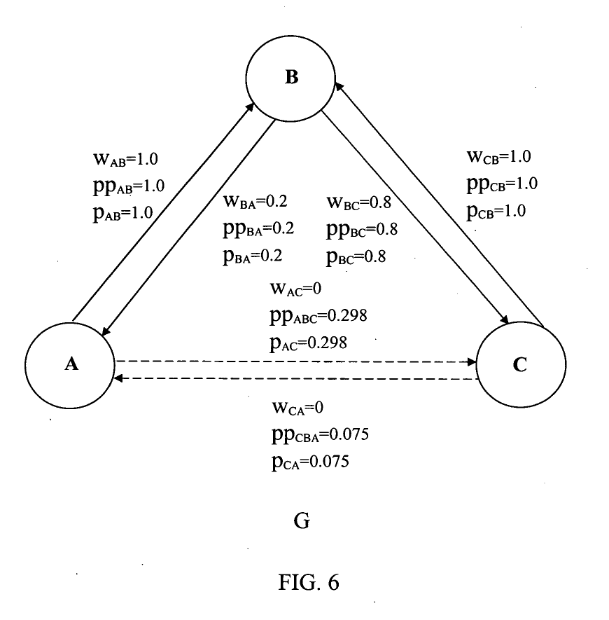

One embodiment of the pending patent application 13317794 is shown in FIG. 6. It is a friendship graph G with user A, B and C. The weighting factors for relations between users are given in FIG. 6. The weighting factor for the relation from B to A w_{BA} is 0.2 while the weighting factor for the relation from B to C w_{BC} is 0.8. There is no direct relation between A and C. However, in real world, A may connect to C via B. In other words, relations may be propagated along a path connecting the two nodes. Moreover, the propagated relations may be attenuated during propagation. In pending patent application 13317794, the propagation attribute of this relation is defined to be attenuatable. Generally, social relations are attenuatable. Not all relations are attenuatable. Non-attenuatable relations are described in pending patent application 13317794. Normally, business relations are non-attenuatable.

In one embodiment of pending patent application 13317270 and 13317794, the weighting factors for attenuatable relations may be interpreted as a predetermined probability of selecting the next node from the current node's neighbors to traverse when searching a social graph. As the next node to visit is always one of vᵢ's neighbors in a social graph, the sum of all weighting factors for relations sourced from vᵢ is 1. That is,

$${\sum }_{j} {w}_{ij} = 1$$

Apparently, wᵢⱼ and wⱼᵢ are not necessarily equal. For this reason, the original undirected G(V, E) is converted to a directed graph G′(V, W), where an edge eᵢⱼ/eⱼᵢ in G is split into two directed edges wᵢⱼ and wⱼᵢ in G′.

wᵢⱼ may be obtained from the closeness of social relation from vᵢ to vⱼ in a social graph. In one embodiment of the present invention, it may be derived from the communications between node vᵢ and vⱼ.

In pending patent application 13317794, proximities of relation between two nodes may be used to describe the closeness of relation between the two nodes in multiple graphs. If the proximity of relation from one node to another is large, the relation between them is close too. Proximities of relation may be calculated from the weighting factors for relations in social graphs and business graphs. More specifically, the proximities of relation between two nodes may be determined from the weighting factors for relations on the paths connecting the two nodes.

There may be a number of paths from a first node to a second node in a social graph. If the propagated relations between two nodes are attenuatable, path proximity may be defined to describe the propagated relations from the first node to the second node along a path. In one embodiment of pending patent application 13317794, proximity of attenuatable relation pᵢⱼ from node vᵢ to vⱼ is defined as

$${p}_{ij} = {max}_{l} {pp}_{ijl}$$

which is the maximum path proximity from vᵢ to vⱼ. ppᵢⱼ is the proximity for path l. Path l is one of the paths connecting vᵢ to vⱼ.

Similar to the asymmetry of weighting factors, proximities are asymmetric as well. Specifically, proximity pᵢⱼ may not be equal to pⱼᵢ.

The proximity of a path may be calculated from the weighting factors for relations on the path. Moreover, the probability of visiting node vⱼ from bᵢ following a path should be the multiplication of the probabilities for connections on the path. Therefore, in one embodiment of pending patent application 13317794, path proximity ppᵢⱼₗ may be calculated as

ppᵢⱼₗ=Πwₛₜ

where wₛₜ is the weighting factor for the relation from vₛ to vₜ on path l connecting vᵢ to vⱼ.

The propagation of attenuatable relation across neighboring nodes should be an attenuating process. A propagation coefficient α is defined and should be in the interval of [0, 1]. Accordingly, in one embodiment of pending patent application 13317794, the path proximity ppᵢⱼₗ may be defined as

ppᵢⱼₗ=Πw′ₛₜ

where w′ₛₜ is equal to α*wₛₜ except for the last connection on the path. The w′ₛₜ for the last connection on the path is equal to wₛₜ.

The path proximities and proximities are shown in FIG. 6. Assuming propagation coefficient α is 0.373, the path proximity pp_{ABC}=w_{AB}*α*w_{BC}=1.0*0.373*0.8 =0.298. pp_{ABC} is the largest path proximity between A and C, therefore, p_{AC} is 0.298 as well.

So far, closeness of social relation between nodes in a social graph may be determined. However, P₆ and S in FIG. 5 are not connected in G₀. Some scheme needs to be designed to determine the closeness of social relation between P₆ and S. To determine the closeness of social relation between P₆ and S, the business relation between B₁ and S may be converted to a social relation.

Business relation and social relation have something in common. That is, both of them carry a certain level of trust and credibility. In this sense, the social graphs and the business graph may be merged into one social graph. The weighting factors for relations in the merged graph may be determined from the weighting factors for relations in the social graphs and weighting factors for relations in the business graph. In one embodiment of pending patent application 13317794, the weighting factors for relations in the merged graph are weighted sum of the weighting factors for relations in the social graphs and the converted weighting factors for business relations in the business graph.

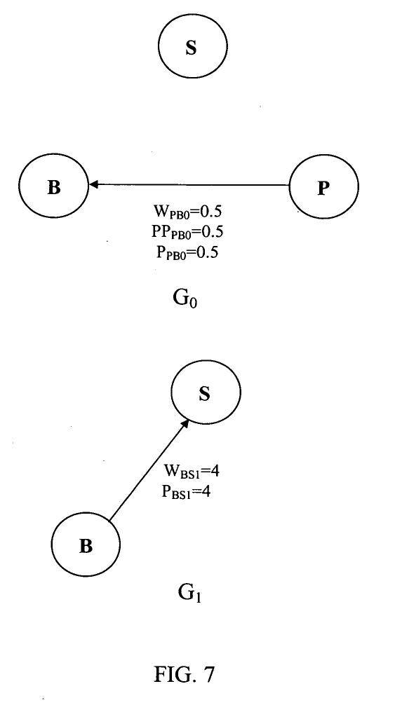

FIG. 7 shows an example of determining closeness of social relation from a potential buyer to a seller. There are a social graph G₀ and a business graph G₁ in FIG. 7. Please note that not all relations are shown in FIG. 7.

The weighting factor for relation from P to B w_{PB0} is 0.5. The path proximity pp_{PB0} and the proximity of social relation p_{PB0} are 0.5. Seller S is not connected to B and P in G₀. B is connected to S in G₁, which means B and S have conducted one or more business transactions. Buyer B has given seller S a rating of 4 out of a scale of 5. In one embodiment of pending patent application 13317794, the weighting factor w_{BS1} is determined as 4 from B's rating on S.

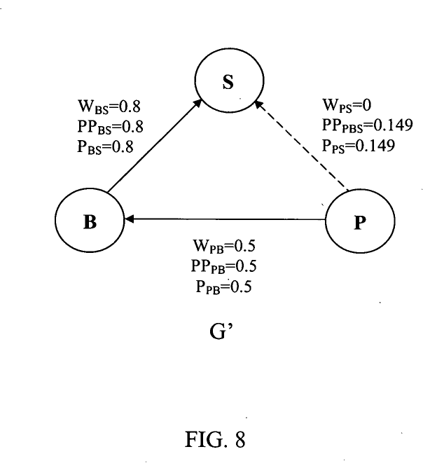

As shown in FIG. 8, G₀ and G₁ may be merged into one graph G′. The weighting factor w_{BS} in G′ may be determined from w_{BS1} in FIG. 7. In one embodiment of the present invention, w_{BS} is assigned the value of normalized w_{BS1} in FIG. 7 w_{BS}=w_{BS1}/5=4/5=0.8. Assuming the propagation coefficient α is 0.373, path proximity pp_{PBS} may be calculated as pp_{PBS}=w_{PB}*α*w_{BS}=0.5*0.373*0.8=0.149. Assuming this is the largest path proximity from P to S, the proximity of social relation from P to S p_{PS} may be calculated as p_{PS}=pp_{PBS}=0.149.

As shown above, in pending patent application 13317794, the closeness of social relation between buyers and sellers may be determined from proximities between nodes in social graphs and business graphs. Likewise, as shown in pending patent application 13317270, the closeness of social relation between buyers and sellers may also be determined from distances between nodes in social graphs.

From the closeness of social relation between buyers and sellers, the level of trust and credibility between them may be derived. This information may be provided to buyers and sellers as an aid in the process of sales decision making.

Moreover, in case a buyer has questions regarding a seller or the seller's item, the buyer may ask one or more persons on the paths connecting the buyer to the seller. In one embodiment of the present invention, the buyer may ask one or more persons on the path with the maximum closeness of relation from the buyer to the seller. Likewise, in case a seller has questions regarding a buyer, the seller may ask one or more persons on the paths connecting the seller to the buyer. In one embodiment of the present invention, the seller may ask one or more persons on the path with the maximum closeness of relation from the seller to the buyer.

As shown in pending patent application 13317794, social graphs and business graphs may be used to find business opportunities for online buyers and sellers. In real world, a buyer may ask his/her friends who have bought from a seller about their opinions about the seller. Conversely, a seller may extrapolate his/her opinions on some people in a circle of friends to other people in the same circle of friends. The opinions obtained this way may not be necessarily correct. Nonetheless, the derived opinions may serve as a first order approximation to the true opinions. Thus, social graphs may be used to find possible new buyers and sellers.

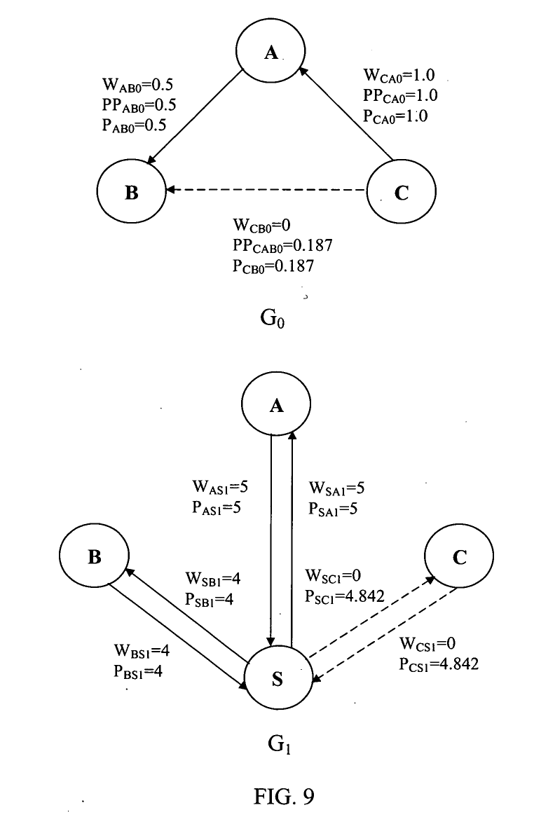

One example is given in FIG. 9. Note that not all relations are shown in FIG. 9. There are two graphs G₀ and G₁ in this example. G₀ is a friendship graph. G₁ is a business graph. Node S represents a seller. A and B are buyers who have done business with S. The weighting factor w_{AS1} describes the closeness of business relation from A to S and is assigned the review of buyer A for seller S, which is 5 in the scale of [0, 5]. Similarly, the weighting factor w_{BS1} describes the closeness of business relation from B to S and is assigned the review of buyer B for seller S, which is 4.

There is no business relation from C to S in G₁, which means C may have never conducted business with S. C may ask his/her friend A and B about seller S. In this way, C may get an opinion about S from A and B. In this particular case, apparently the business relation is not attenuatable. In pending patent application 13317794, the propagation attribute of the business relation between buyers and sellers is defined to be non-attenuatable. Moreover, pending patent application 13317794 presents a method to calculate proximities of business relation, i.e. proximities of non-attenuatable relation, between nodes using social relations (attenuatable relations) and business relations(non-attenuatable relations).

In FIG. 9, an intuitive prediction for C's review on S is a weighted sum of A and B's reviews on S. The weights of the sum may be determined from C's proximities of attenuatable relation with A and B. More specifically, proximity of business relation, i.e. proximity of non-attenuatable relation, from C to S P_{CS1} may be calculated as P_{CS1}=(P_{CA0}/(P_{CA0}+P_{CB0}))*P_{AS1}+(P_{CB0}/(P_{CA0}+P_{CB0}))*P_{BS1}=(1.0/(1.0+0.187))*5+(0.187/(1.0+0.187))*4=4.842.

Assuming S's opinions about A and B are w_{SA1} and w_{SB1} respectively, S's proximity of business relation, i.e. proximity of non-attenuatable relation, with C P_{SC1} may be calculated as P_{SC1}=(P_{CA0}/(P_{CA0}+P_{CB0}))*P_{SA1}+(P_{CB0}/(P_{CA0}+P_{CB0}))*P_{SB1}=(1.0/(1.0+0.187))*5+(0.187/(1.0+0.187))*4=4.842. The proximity of business relation from S to C may be interpreted as S's opinion on C.

FIG. 9 is an interesting example. It shows that it is possible to predict business relations between nodes in G₁ based on the social relations in G₀ and the business relations in G₁. When the closeness of business relation between buyers and sellers is determined, finding possible buyers for a seller is converted to a search in a business graph starting from the seller. The search is performed in the order of business relation closeness with the seller. Buyers having closer business relation with the seller may more likely buy goods and services from the seller. Conversely, finding possible sellers for a buyer is converted to a search in a business graph starting from the buyer. The search is performed in the order of business relation closeness with the buyer. A buyer may more likely buy goods and services from sellers having closer business relation with the buyer.

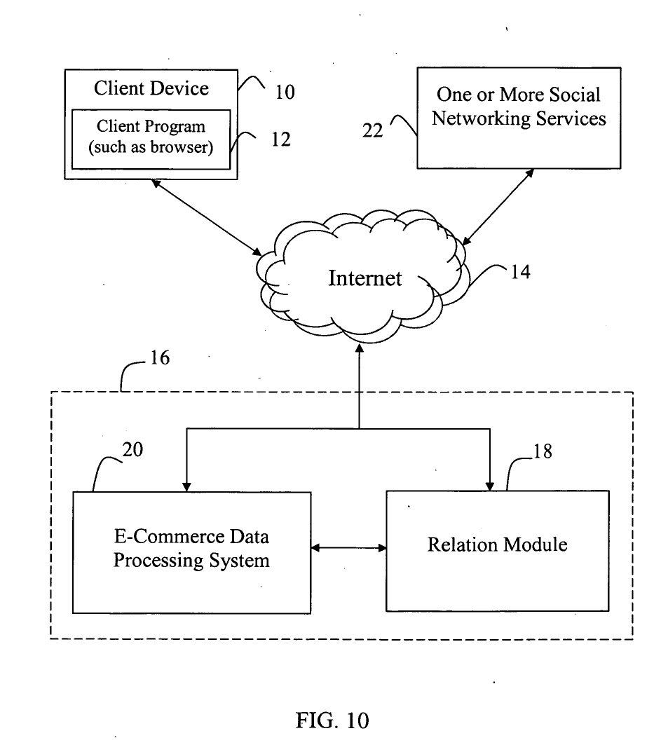

FIG. 10 shows an embodiment of a system (block 16) in accordance with the present invention. In this embodiment, the system (block 16) may be accessed with a client device (block 10) such as a computer or a mobile device via internet (block 14). A client program (block 12) such as an internet browser or a native application is running on the client device (block 10). The system (block 16) may obtain a client's information of profile, relations, groups, messages, etc., from one or more social networking services (block 22) with the client's permission.

One embodiment of the system (block 16) may comprise an e-commerce data processing system (block 20) and a relation module (block 18). The e-commerce data processing system (block 20) may perform all the functions of a typical online buying and selling service such as an online shopping site or an online auction site. It may handle seller listing requests and buyer purchase requests. It may provide all the facilities required to complete a buying and selling transaction including payment support and search features. Additionally it may provide relation features. In particular, it may search for potential buyers and sellers. The found potential buyers and sellers may be recommended to sellers and buyers respectively. It may also provide information of social relation closeness and business relation closeness between buyers and sellers. Moreover, it may provide access control to the listing of a seller's item.

The relation module (block 18) may obtain a client's information including but not limited to profile, relations, groups, and messages from one or more social networking services (block 22) with the client's permission. It may determine the closeness of social relation between nodes in social graphs. Moreover, it may determine the closeness of business relation between buyers and sellers. This module may provide support for potential buyers and sellers search.

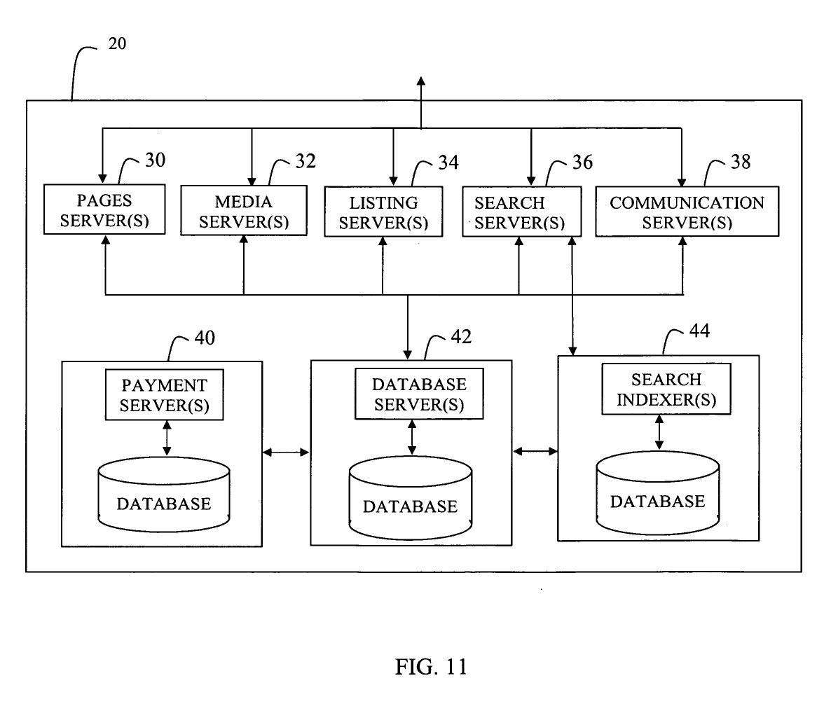

FIG. 11 shows an embodiment of the e-commerce data processing system (block 20). It may include a number of front-end servers including page server(s) (block 30), media server(s) (block 32), listing server(s) (block 34), search server(s) (block 36) and communication server(s) (block 38). The page server(s) (block 30) may provide web pages. The media server(s) (block 32) may provide pictures and videos for the listed items. The listing server(s) (block 34) may provide listing service to sellers. The search server(s) (block 36) may provide search function to users. The communications server(s) (block 38) may provide email, messaging, phone services to users. The communications server(s) (block 38) may also leverage messaging, phone and email services provided by social networking services (block 22).

The front-end servers may be supported by a number of back-end servers including payment server(s) (block 40), database server(s) (block 42) and search indexer(s) (block 44).

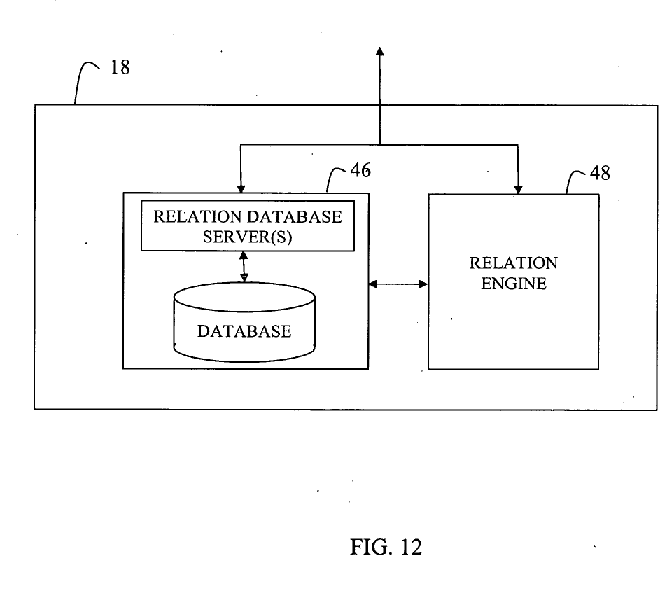

One embodiment of the relation module (block 18) is shown in FIG. 12. It may include a relation engine (block 48) and a relation database server (block 46). The relation engine (block 48) may obtain information including but not limited to profiles, relations, groups and messages from social networking services (block 22) with permissions and may determine the closeness of social relation between entities. It may also determine the closeness of business relation between entities. The relation database server (block 46) may store the social relation and business relation information and may serve relation data requests from the e-commerce data processing system (block 20).

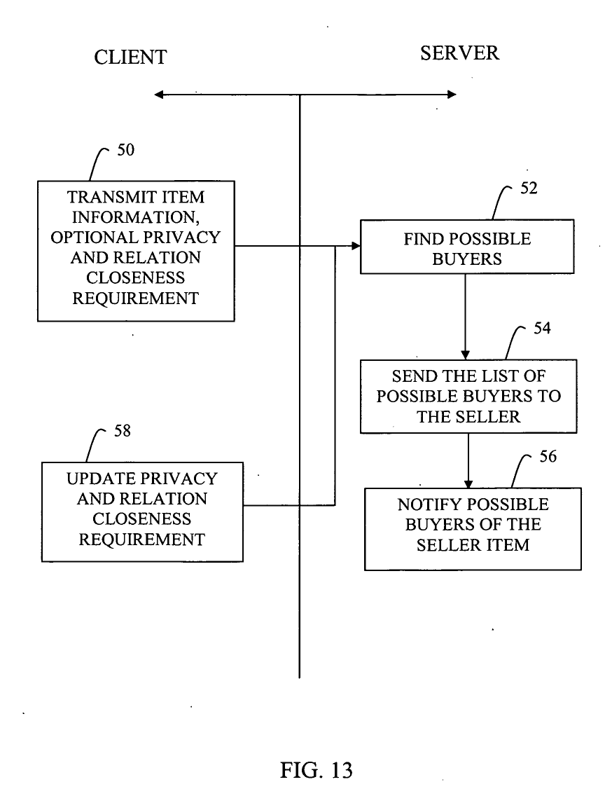

FIG. 13 shows a flow chart showing one embodiment of a seller's interaction with the system (block 16). A seller may use a client program (block 12) to send listing information about an item (block 50). The seller may limit the access of the listing inform by either specifying a group or specifying the closeness of social relation and the closeness of business relation required for access. The specified group may be either obtained from social networking services (block 22) or created by the seller. In this way, the seller may achieve desired privacy and a certain level of credibility and trust. In one embodiment of the present invention, a seller may only allow his/her direct friends to access the listing information.

The system (block 16) may receive the listing and privacy information from a seller. Based on the requirement on privacy and the closeness of social and business relation, as shown in block 52, the system (block 16) may find a list of potential buyers and may send the list of potential buyers to the seller (block 54). Then the found potential buyers may be notified of the listing of the item (block 56). If no potential buyer is found, the seller may update the requirement on privacy and closeness of social and business relation (block 58).

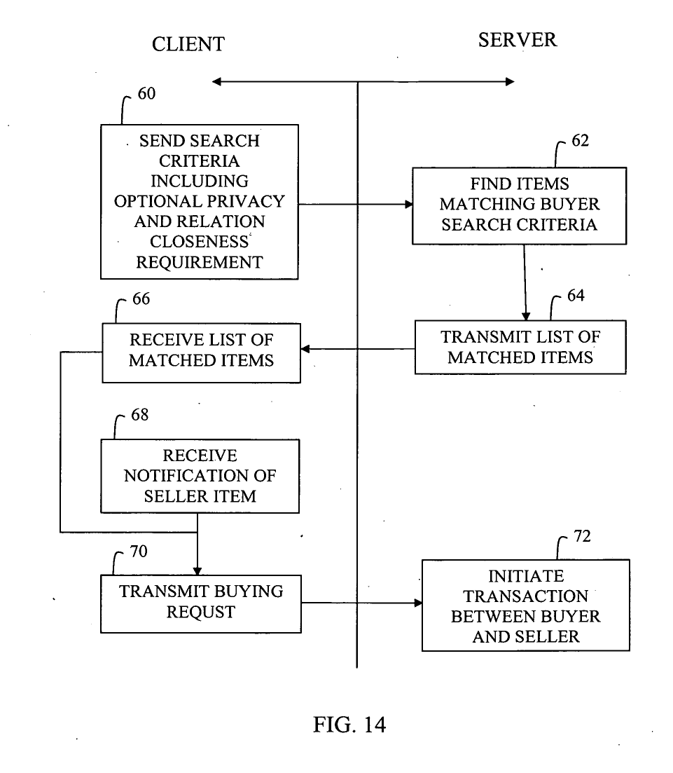

FIG. 14 shows a flow chart showing one embodiment of a buyer's interaction with the system (block 16). A buyer may search item information (block 60). The search criteria may include requirement on privacy and the closeness of social and business relation with the buyer. The system (block 16) may receive the search criteria and may find the matched items from search server (block 36) as shown in block 62. The information of the matched items may be sent to the buyer (block 64). The buyer may receive the list of matched items (block 66). Then the client may decide the items to buy and may send the buying request of a list of interested items to the server (block 70). Alternatively, the buyer may receive notification of a seller item listing (block 68) and may decide to buy the item. When the server receives the order information, it may initiate the transaction between the buyer and the seller (block 72).

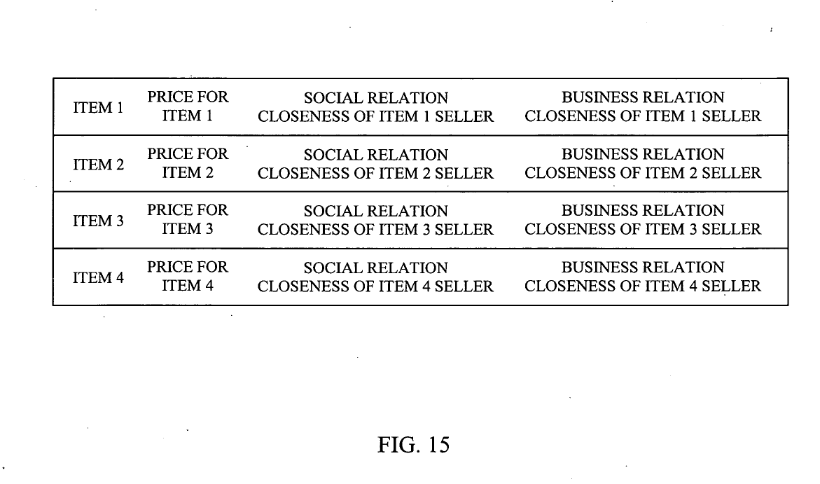

FIG. 15 shows one embodiment of the listing of items on a client application program (block 12). In addition to conventional item information, the information about closeness of social and business relation from a buyer to a seller may also be displayed. The list of items may or may not be sorted. In one embodiment of the present invention, the list may be sorted in terms of prices. In another embodiment of the present invention, the list may be sorted in terms of sellers' social relation closeness or business relation closeness with the buyer.

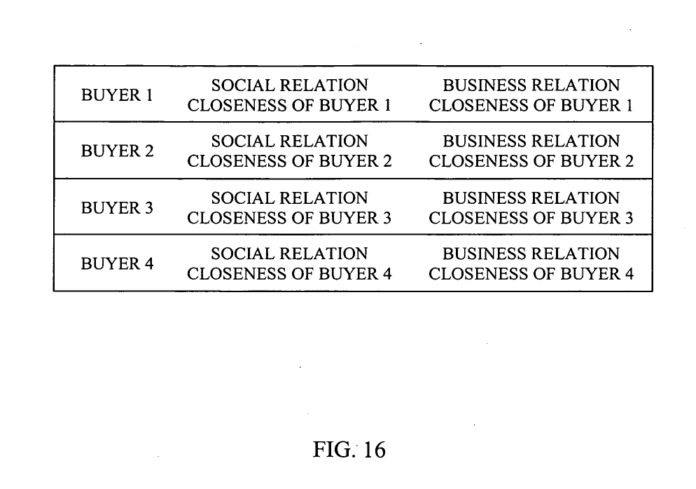

FIG. 16 shows one embodiment of the listing of potential buyers on a seller's client application program (block 12). In addition to conventional buyer information, the information about closeness of social and business relation from a seller to a buyer may be displayed. In the case of online auction, the prices offered by buyers may be displayed as well. In one embodiment of the present invention, the list may be sorted in terms of sellers' social relation closeness or business relation closeness with the buyer. In another embodiment of the present invention, if the prices offered are distinct, the list may be sorted in terms of prices.

In one embodiment of the present invention, a path connecting a buyer and a seller may be displayed on client application program (block 12). Moreover, the system (block 16) may provide one or more persons on a path connecting a buyer and a seller such that a buyer and a seller may ask for more information to aid the process of sale decision making.

It should be noted that the present invention may be applied to one or more social graphs obtained from one or more social networking services.

The present invention has been disclosed and described with respect to the herein disclosed embodiments. However, these embodiments should be considered in all respects as illustrative and not restrictive. Other forms of the present invention could be made within the spirit and scope of the invention.

What is claimed is:

1. A system for carrying out online buying and selling items, the system comprising:
a relation module configured to obtain information from a plurality of social networking services with permissions and to determine the closeness of relation between a buyer and a seller, wherein the closeness of social relation between a buyer and a seller is determined from the social relations of the buyer, the business relations of the buyer, the social relations of the seller and the business relations of the seller, wherein the closeness of business relation between a buyer and a seller is determined from the business relations of the buyer, the social relations of the buyer, the business relations of the seller and the social relations of the seller; and
an e-commerce data processing system configured to receive sellers and items information and to provide sellers with buyers information including offered prices if needed, the e-commerce data processing system further configured to provide buyers with sellers and items information and to receive buyers information including offered prices if needed, wherein the e-commerce data processing system is configured to provide relation information to buyers and sellers, the relation information being obtained from the relation module and being used in the decisions of buyers and sellers, wherein the e-commerce data processing system is further configured to initiate and complete the transactions between buyers and sellers.

2. A system according to claim 1 wherein the online buying and selling items includes online auction.

3. A system according to claim 1 wherein the relation information provided to buyers and sellers includes closeness of social relation between buyers and sellers.

4. A system according to claim 1 wherein the relation information provided to buyers and sellers includes closeness of business relation between buyers and sellers.

5. A system according to claim 1 wherein the relation information provided to buyers and sellers includes one or more persons on a path connecting a buyer and a seller.

6. A system according to claim 1 wherein buyers and sellers may obtain information from one or more persons on a path connecting a buyer and a seller.

7. A system according to claim 1 wherein the e-commerce data processing system is further configured to provide a list of buyers for an item based on the business relation closeness and the social relation closeness with the item's seller, the business relation closeness and the social relation closeness with the seller being provided by the relation module.

8. A system according to claim 7 wherein the e-commerce data processing system is further configured to notify the buyers in the list of the seller's item.

9. A system according to claim 1 wherein the module is further configured to provide a list of sellers selling similar items that a buyer may be interested in buying based on the business relation closeness and the social relation closeness with the buyer, the business relation closeness and the social relation closeness with the buyer being provided by the relation module.

10. A system according to claim 1 wherein the e-commerce data processing system is further configured to allow only buyers having at least a minimum level of social relation closeness and a minimum level of business relation closeness with a seller to access information of the seller's item, the minimum level of social relation closeness and the minimum level of business relation closeness being specified by the seller.

11. A system according to claim 1 wherein the e-commerce data processing system is further configured to allow only buyers belonging to a group to access information of an item, the group either being obtained from a plurality of social networking services or being created by the item's seller.

12. A system according to claim 1 wherein the e-commerce data processing system is further configured to allow only a seller's direct friends to access information of the seller's item.

13. A system according to claim 1 wherein the relation module is further configured to obtain information from one social networking service with permissions.

14. A method for carrying out online buying and selling items includes:
obtaining information from a plurality of social networking services with permissions;
determining the closeness of social relation between a buyer and a seller, the closeness of social relation between a buyer and a seller being dependent on the social relations of the buyer, the business relations of the buyer, the social relations of the seller and the business relations of the seller;
determining the closeness of business relation between a buyer and a seller, the closeness of business relation between a buyer and a seller being dependent on the business relations of the buyer, the social relations of the buyer, the business relations of the seller and the social relations of the seller;
receiving sellers and items information;
transmitting the sellers and items information and the relation information between the buyers and the sellers to the buyers;
receiving buyers information including offered prices if needed;
transmitting the buyers information including offered prices if needed and the relation information between the buyers and the sellers to the sellers;
receiving sellers' sales decisions;
transmitting the sellers' sales decisions to the buyers;
initiating the transactions between the sellers and the buyers; and
completing the transactions between the sellers and the buyers.

15. A method according to claim 14 wherein the online buying and selling goods and services includes online auction.

16. A method according to claim 14 wherein the relation information provided to buyers and sellers includes the closeness of social relation between buyers and sellers.

17. A method according to claim 14 wherein the relation information provided to buyers and sellers includes the closeness of business relation between buyers and sellers.

18. A method according to claim 14 wherein the relation information provided to buyers and sellers includes one or more persons on a path connecting a buyer and a seller.

19. A method according to claim 14 wherein buyers and sellers may obtain information from one or more persons on a path connecting a buyer and a seller.

20. A method according to claim 14 wherein the method further includes:
determining a list of buyers for an item based on the closeness of business relation and the closeness of social relation with the item's seller; and
transmitting the list of buyers to the seller.

21. A method according to claim 20 wherein the method further includes:
notifying buyers in the list of the seller's item.

22. A method according to claim 14 wherein the method further includes:
determining a list of sellers selling similar items that a buyer may be interested in buying based on the closeness of business relation and the closeness of social relation with the buyer; and
transmitting the list of sellers to the buyer.

23. A method according to claim 14 wherein the transmitting the sellers and items information includes:
transmitting the sellers and items information and the relation information between the buyers and the sellers to only buyers having at least a minimum level of social relation closeness and a minimum level of business relation closeness with a seller, the minimum level of social relation closeness and the minimum level of business relation closeness being specified by the seller.

24. A method according to claim 14 wherein the transmitting the sellers and items information includes:
transmitting the sellers and items information and the relation information between the buyers and the sellers to only buyers belonging to a group, the group either being obtained from a plurality of social networking services or being created by the item's seller.

25. A method according to claim 14 wherein the transmitting the sellers and items information to the buyers includes:
transmitting the sellers and items information and the relation information between the buyers and the sellers to only the sellers' direct friends.

26. A method according to claim 14 wherein the obtaining information includes:
obtaining information from one social networking service with permissions.
